(19) United States
(12) Patent Application Publication
(10) Pub. No.: US 2006/0115770 A1
(43) Pub. Date: Jun. 1, 2006

(54) Printed circuit board including embedded capacitor and method of fabricating same

(75) Inventors: Jong Kuk Hong, Chungcheongnam-do (KR); Chang Sup Ryu, Daejeon (KR); Ho Sik Jeon, Chungcheongbuk-do (KR); Seok Kyu Lee, Chungcheongbuk-do (KR)

Correspondence Address: DARBY & DARBY P.C., P. O. BOX 5257, NEW YORK, NY, 10150-5257, US

(73) Assignee: Samsung Electro-Mechanics Co., Ltd., Kyunggi-do (KR)

(21) Appl. No.: 11/058,998

(22) Filed: Feb. 15, 2005

(30) Foreign Application Priority Data
Dec. 1, 2004 (KR) 2004-99898

(51) Int. Cl. G03C 5/00

(52) U.S. Cl. 430/311

(57) ABSTRACT

Disclosed is a PCB including an embedded capacitor, in which a dielectric layer and an upper electrode layer are formed after a lower electrode layer of the embedded capacitor is formed, thereby providing a microcircuit pattern on a circuit layer having a lower electrode layer formed thereon, and a method of fabricating the same.

### INCORPORATION BY REFERENCE

The present application claims priority under 35 U.S.C. §119 to Korean Patent Application No. 2004-99898 filed on Dec. 1, 2004. The content of the application is incorporated herein by reference in its entirety.

### BACKGROUND OF THE INVENTION

1. Field of the Invention

The present invention relates, in general, to a printed circuit board (PCB) including an embedded capacitor and a method of fabricating the same and, more particularly, to a PCB including an embedded capacitor, in which a dielectric layer and an upper electrode layer are formed after a lower electrode layer of the embedded capacitor is formed, thereby providing a microcircuit pattern on a circuit layer having the lower electrode layer formed thereon, and a method of fabricating the same.

2. Description of the Prior Art

Recently, electronic technologies are moving toward the embedding of resistors, capacitors, integrated circuits (IC) and the like into a substrate so as to comply with the demand for miniaturization and sophisticated functions of electronic goods according to advances in the electronics industry.

Typically, discrete chip resistors or discrete chip capacitors have been frequently mounted on most PCBs, but, recently, PCBs are developing in which resistors or capacitors are embedded.

The embedded PCB has a structure in which the capacitor is mounted on the external part of the PCB or embedded in the internal part of the PCB, and if the capacitor is integrated with the PCB to act as one part of the PCB regardless of the size of the PCB, the capacitor is called an “embedded (buried) capacitor” and the resulting PCB is called “printed circuit board including embedded capacitor”.

FIGS. 1a to 1n are sectional views illustrating a conventional procedure of fabricating a PCB including an embedded capacitor, and FIG. 2 is a plane view of a lower electrode layer of the PCB including the embedded capacitor which is fabricated through the procedure of FIGS. 1a to 1n.

As shown in FIG. 1a, a copper clad laminate, in which a first copper foil layer 12 is formed on an insulating layer 11, is prepared.

As shown in FIG. 1b, a photosensitive dielectric material 13 is layered on the first copper foil layer 12.

As shown in FIG. 1c, a second copper foil layer 14 is laminated on the photosensitive dielectric material 13.

As shown in FIG. 1d, a photosensitive film 20a is laminated on the second copper foil layer 14.

As shown in FIG. 1e, a photomask 30a, on which a predetermined capacitor pattern is formed, is closely adhered to the photosensitive film 20a, and subsequently irradiated with ultraviolet rays 40a. At this stage, ultraviolet rays 40a penetrate an unprinted portion 31a of the photomask 30a to form a hardened portion 21a of the photosensitive film 20a under the photomask 30a. Ultraviolet rays 40a do not penetrate a black printed portion 32a of the photomask 30a, thus an unhardened portion 22a of the photosensitive film 20a remains under the photomask 30a.

As shown in FIG. 1f, after the photomask 30a is removed, a development process is conducted to remove the unhardened portion 22a of the photosensitive film 20a while only the hardened portion 21a of the photosensitive film 20a remains.

As shown in FIG. 1g, the second copper foil layer 14 is etched using the hardened portion 21a of the photosensitive film 20a as an etching resist, thereby forming an upper electrode layer 14a of an embedded capacitor thereon.

As shown in FIG. 1h, after the hardened portion 21a of the photosensitive film 20a is removed, ultraviolet rays 40b are radiated onto the photosensitive dielectric material 13 using the upper electrode layer 14a as a mask. At this stage, a portion of the photosensitive dielectric material 13, on which the upper electrode layer 14a is not formed, absorbs ultraviolet rays 40b to form a reacted portion 13b, which is capable of being decomposed during a development process using a special solvent (for example, GBL (gamma-butyrolactone)). The other portion of the photosensitive dielectric material 13, on which the upper electrode layer 14a is formed, does not absorb ultraviolet rays 40b, resulting in the persistence of an unreacted portion 13a.

As shown in FIG. 1i, the development process is conducted to remove the portion 13b of the photosensitive dielectric material 13, which reacted due to the ultraviolet rays, thereby forming a dielectric layer 13a of the embedded capacitor on the photosensitive dielectric material 13.

As shown in FIG. 1j, a photosensitive resin 20b is layered on the first copper foil layer 12, the dielectric layer 13a, and the upper electrode layer 14a.

As shown in FIG. 1k, a photomask 30b, on which a predetermined circuit pattern is formed, is closely adhered to the photosensitive resin 20b, and then irradiated with ultraviolet rays 40c. At this stage, ultraviolet rays 40c penetrate an unprinted portion 31b of the photomask 30b to form a hardened portion 21b of the photosensitive resin 20b under the photomask 30b. Ultraviolet rays 40c do not penetrate a black printed portion 32b of the photomask 30b, thus an unhardened portion 22b of the photosensitive resin 20b remains under the photomask 30b.

As shown in FIG. 11, after the photomask 30b is removed, a development process is conducted to remove the unhardened portion 22b of the photosensitive resin 20b while only the hardened portion 21b of the photosensitive resin 20b remains.

As shown in FIG. 1m, the first copper foil layer 12 is etched using the hardened portion 21b of the photosensitive resin 20b as an etching resist, thereby forming a lower electrode layer 12a and the circuit pattern 12b of the embedded capacitor thereon.

As shown in FIG. 1n, the hardened portion 21b of the photosensitive resin 20b is removed. After an insulating layer is laminated, circuit pattern formation, solder resist formation, nickel/gold plating, and external structure formation processes are implemented, thereby creating the PCB 10 including the embedded capacitor.

The conventional procedure of fabricating the PCB 10 including the embedded capacitor is schematically disclosed in U.S. Pat. No. 6,349,456.

Meanwhile, recently, an increase in a self resonance frequency (SRF) of a passive component, such as a capacitor, which is mounted on a PCB, is required according to a frequency increase needed in a high-frequency system. Furthermore, in a decoupling capacitor used to stabilize a power source, it is necessary to reduce impedance at a high frequency.

To increase the SRF of the capacitor and reduce impedance at the high frequency, demand for an embedded capacitor, which is capable of reducing inductance parasitic in a capacitor, is growing. In PCB design, since the integration of circuit patterns continuously increases, circuit patterns must be made fine.

However, in the conventional PCB 10 including the embedded capacitor, as shown in FIG. 1k, surface level variation occurs between the photomask 30b and the photosensitive resin 20b during an exposure process, causing diffraction of ultraviolet rays 40c at a corner of the black printed portion 32b of the photomask 30b. Thus, as shown in FIG. 11, the conventional PCB has an undesirable lower limit to the width of a pattern of the photosensitive resin 20b.

Therefore, as shown in FIG. 2, undesirably, an L/S (line/space) value that denotes a width of the circuit pattern 12b, which is formed on the layer on which the lower electrode layer 12a is formed, and a space between the circuit patterns 12b has a limit value of 75 μm/75 μn.

Additionally, as shown in FIG. 1j, in the conventional PCB 10 including the embedded capacitor, the photosensitive resin 20b must be applied on a wall of the dielectric layer 13a so as to protect the dielectric layer 13a during a process of etching the first copper foil layer to form the lower electrode layer 12a and the circuit pattern 12b. Accordingly, as shown in FIG. 1n, a portion of the lower electrode layer 12a protrudes from the upper electrode layer 14a and the dielectric layer 13a.

The protrusion of the lower electrode layer 12a acts as a conductor in a high frequency environment, causing parasitic inductance, resulting in poor electric performance of electronic goods.

### SUMMARY OF THE INVENTION

Therefore, the present invention has been made keeping in mind the above disadvantages occurring in the prior arts, and an object of the present invention is to provide a PCB including an embedded capacitor, in which a microcircuit pattern is capable of being formed on a circuit layer having a lower electrode layer formed thereon, and a method of fabricating the same.

Another object of the present invention is to provide a PCB including an embedded capacitor, in which an unnecessary portion of a lower electrode layer is not formed, thereby preventing the occurrence of parasitic inductance, and a method of fabricating the same.

The above objects can be accomplished by providing a PCB including an embedded capacitor, which comprises an insulating layer; a lower electrode layer formed on the insulating layer; a circuit pattern formed around the lower electrode layer of the insulating layer; an insulating resin packed between the lower electrode layer and the circuit pattern to provide insulation between the lower electrode layer and the circuit pattern; a dielectric layer formed on the lower electrode layer; and an upper electrode layer formed on the dielectric layer.

Furthermore, the present invention provides a method of fabricating a PCB including an embedded capacitor. The method comprises (A) forming a lower electrode layer on an insulating layer and a circuit pattern around the lower electrode layer; (B) layering a photosensitive dielectric material on the lower electrode layer and the circuit pattern, and laminating a copper foil layer on the photosensitive dielectric material; (C) etching the copper foil layer through a photolithography process so as to form an upper electrode layer on a portion of the copper foil layer, which corresponds in position to the lower electrode layer; and (D) exposing and developing the photosensitive dielectric material using the upper electrode layer as a mask so as to form a dielectric layer on the photosensitive dielectric material.

Preferably, the method further comprises (E) packing an insulating resin between the lower electrode layer and the circuit pattern to flatten the surface of a layer containing the lower electrode layer and the circuit pattern after the step (A).

### BRIEF DESCRIPTION OF THE DRAWINGS

The above and other objects, features and other advantages of the present invention will be more clearly understood from the following detailed description taken in conjunction with the accompanying drawings, in which:

FIGS. 1a to 1n are sectional views illustrating a conventional procedure of fabricating a PCB including an embedded capacitor;

FIG. 2 is a plane view of a lower electrode layer of the PCB including the embedded capacitor which is fabricated through the procedure of FIGS. 1a to 1n;

FIG. 3 is a sectional view of a PCB including an embedded capacitor, according to an embodiment of the present invention;

FIGS. 4a to 4o are sectional views illustrating a procedure of fabricating the PCB including the embedded capacitor, according to an embodiment of the present invention;

FIG. 5 is a plane view of a lower electrode layer of the PCB including the embedded capacitor which is fabricated through the procedure of FIGS. 4a to 4o;

FIGS. 6a to 6q are sectional views illustrating a procedure of fabricating a PCB including an embedded capacitor, according to another embodiment of the present invention; and

FIGS. 7a to 7o are sectional views illustrating a procedure of fabricating a PCB including an embedded capacitor, according to yet another embodiment of the present invention.

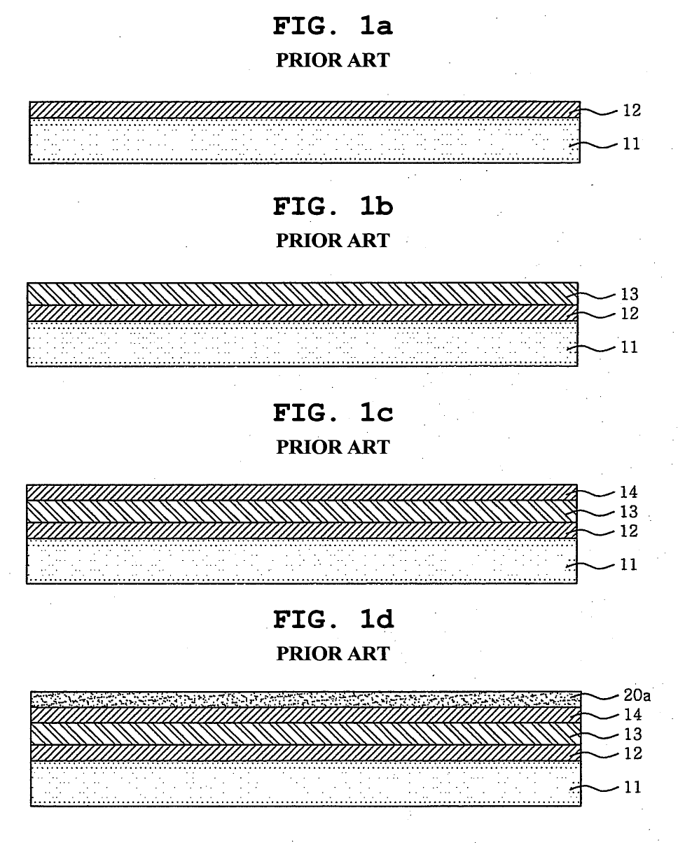

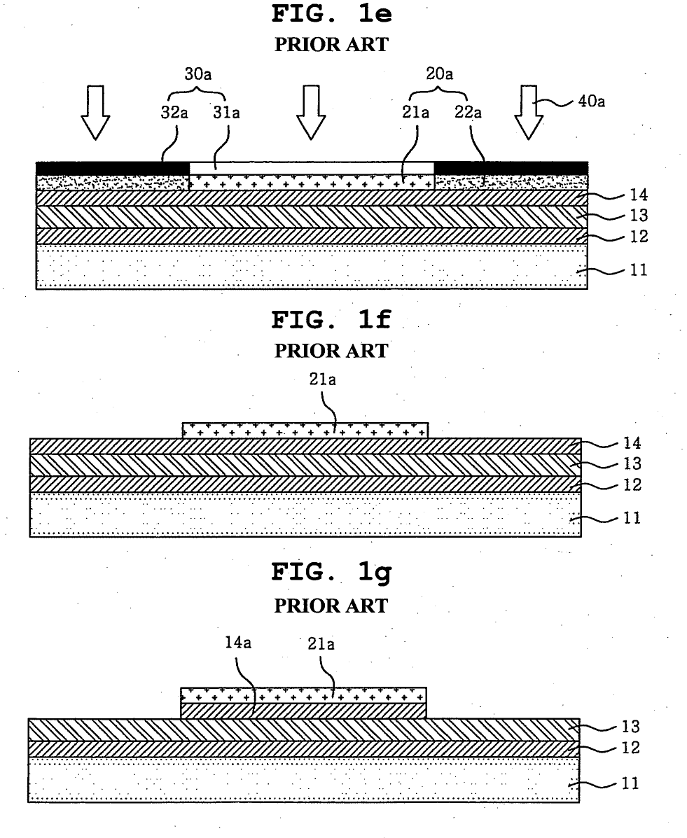

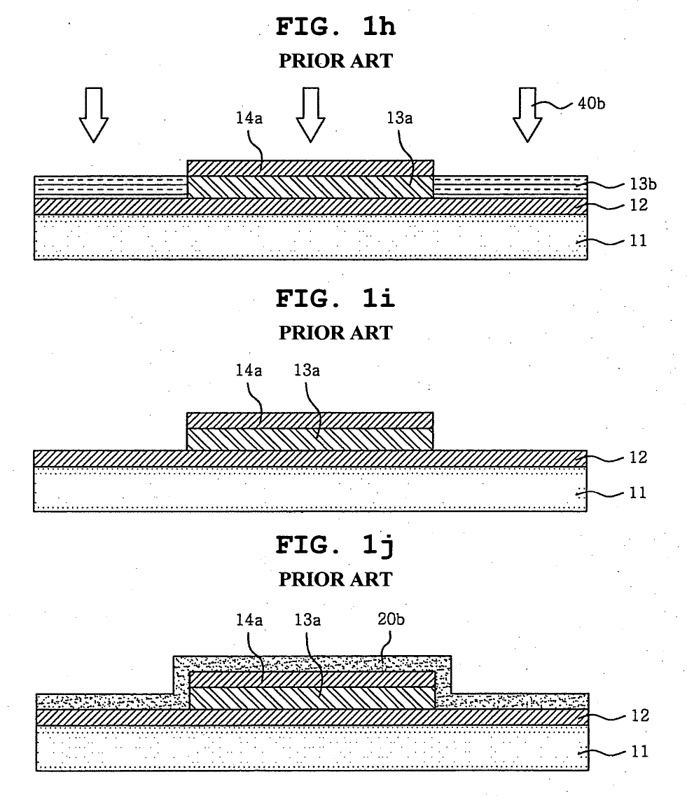

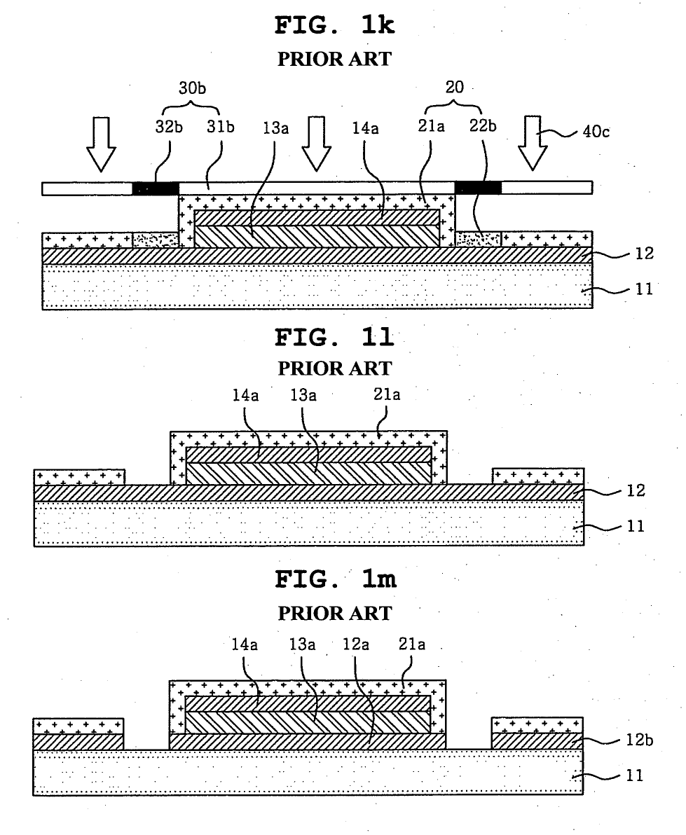

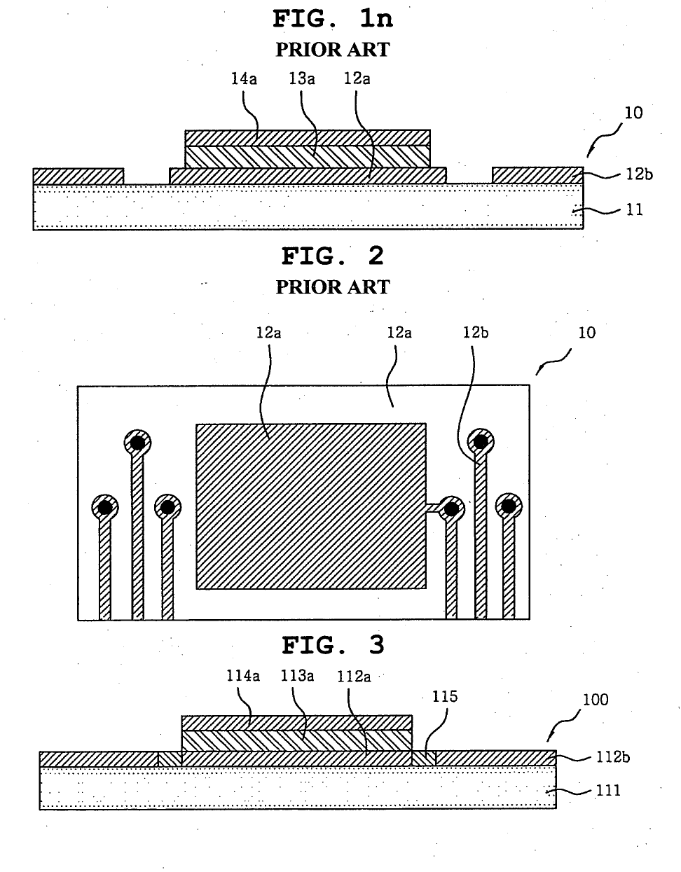

### DETAILED DESCRIPTION OF THE INVENTION

Hereinafter, a detailed description will be given of a PCB including an embedded capacitor and a method of fabricating the same according to the present invention, with reference to the drawings. In the drawings of the present invention, only one side of the PCB is processed, but both sides of the PCB are processed in practice.

FIG. 3 is a sectional view of a PCB including an embedded capacitor, according to an embodiment of the present invention.

As shown in FIG. 3, the PCB 100 including the embedded capacitor according to the present invention comprises an insulating layer 111, a lower electrode layer 112a and a circuit pattern 112b formed on the insulating layer 111, a dielectric layer 113a formed on the lower electrode layer 112a, an upper electrode layer 114a formed on the dielectric layer 113a, and an insulating resin 115 packed between the lower electrode layer 112a and the circuit pattern 112b.

The insulating layer 111 is interposed between circuit layers to insulate the circuit layers from each other. Preferably, it is made of a reinforcing material, such as paper, glass fiber, or a glass non-woven fabric, and a thermosetting resin, such as epoxy, polyimide, or bismaleimide triazine (BT) resins.

The lower electrode layer 112a is formed on the insulating layer 111, and acts as an electrode of the embedded capacitor. In the present embodiment, it is preferable that a copper foil layer or a copper plating layer, which is formed on the insulating layer 111, be subjected to a photolithography process to form the lower electrode layer 112a.

The circuit pattern 112b is formed around the lower electrode layer 112a on the insulating layer 111, and acts as a path for electric signals of the PCB 100. In the present embodiment, it is preferable that a copper foil layer or a copper plating layer, which is formed on the insulating layer 111, be subjected to a photolithography process to form the circuit pattern 112b in conjunction with the lower electrode layer 112a.

The dielectric layer 113a is formed on the lower electrode layer 112a, and made of a material having a high dielectric constant to provide high capacitance to the capacitor. In the present embodiment, it is preferable that the dielectric layer 113a be made of a photosensitive dielectric material that reacts to ultraviolet rays.

The upper electrode layer 114a is formed on the dielectric layer 113a, and acts as an electrode of the embedded capacitor like the lower electrode layer 112a. In the present embodiment, it is preferable that a copper foil layer or a copper plating layer, which is formed on the dielectric layer, be subjected to a photolithography process to form the upper electrode layer 114a.

The insulating layer 115 is packed between the lower electrode layer 112a and the circuit pattern 112b to insulate the lower electrode layer 112a and the circuit pattern 112b from each other. Furthermore, the insulating resin 115 is packed between the lower electrode layer 112a and the circuit pattern 112b to flatten the surface of the resulting layer, thereby contributing to the uniform application of the photosensitive dielectric material onto the lower electrode layer 112a and the circuit pattern 112b.

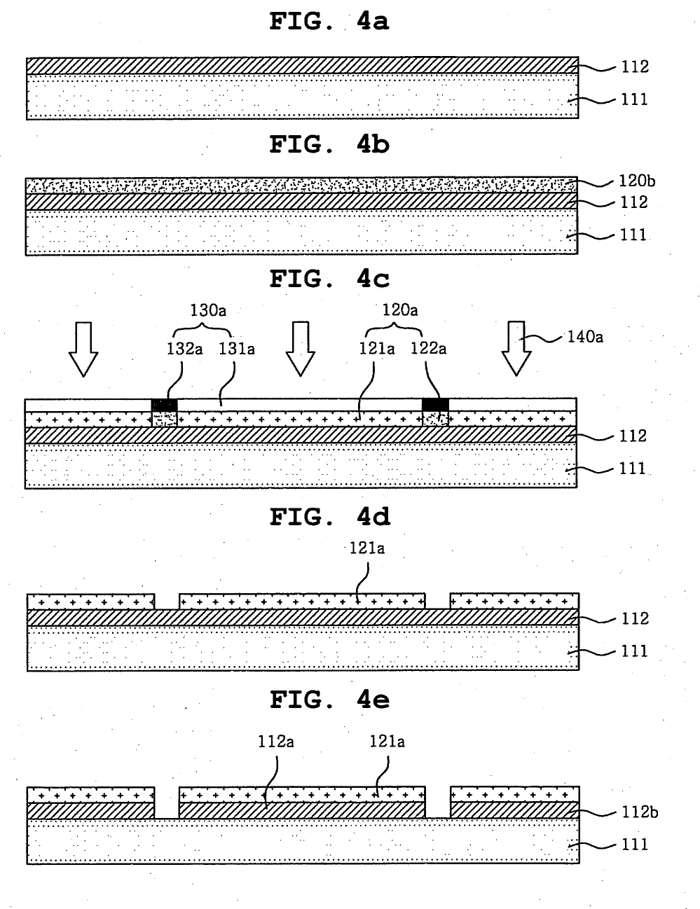

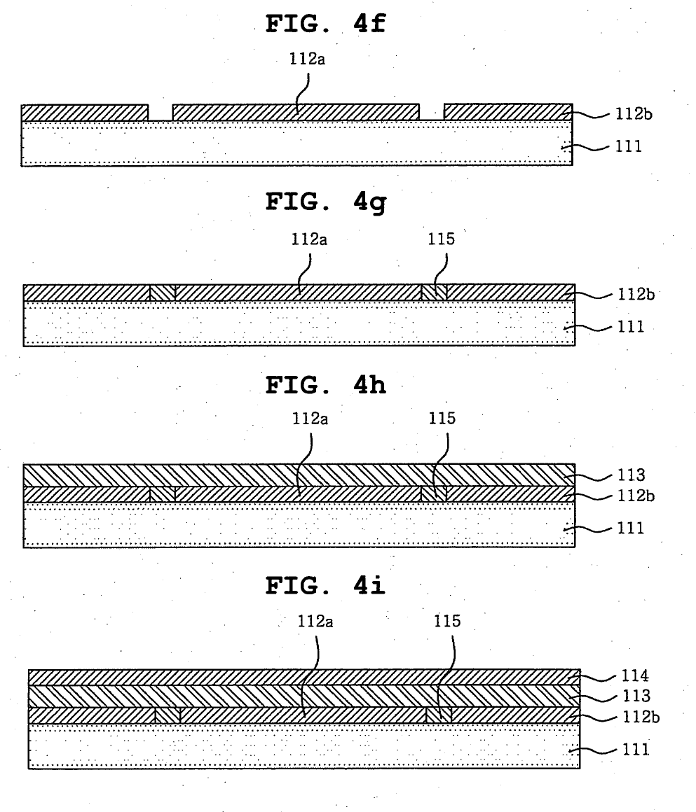

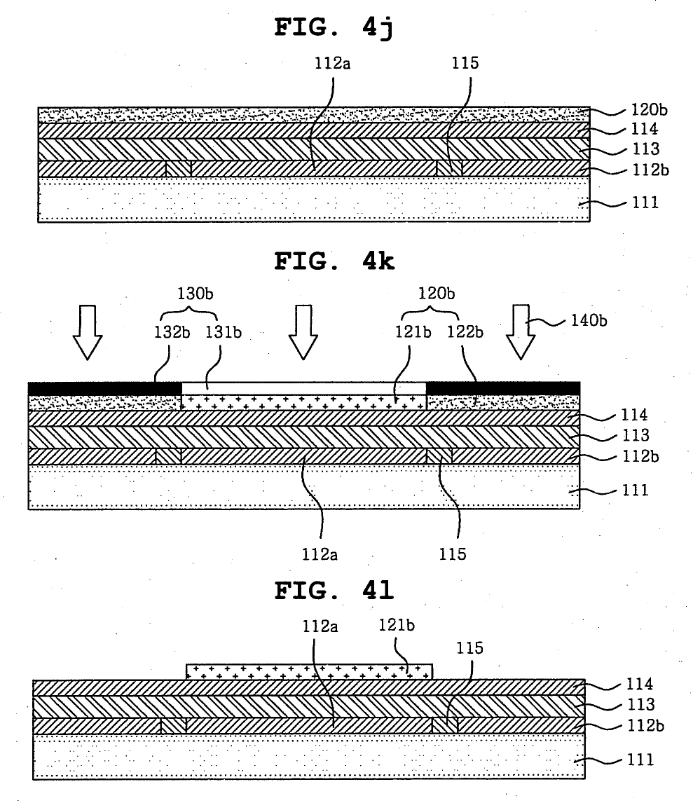

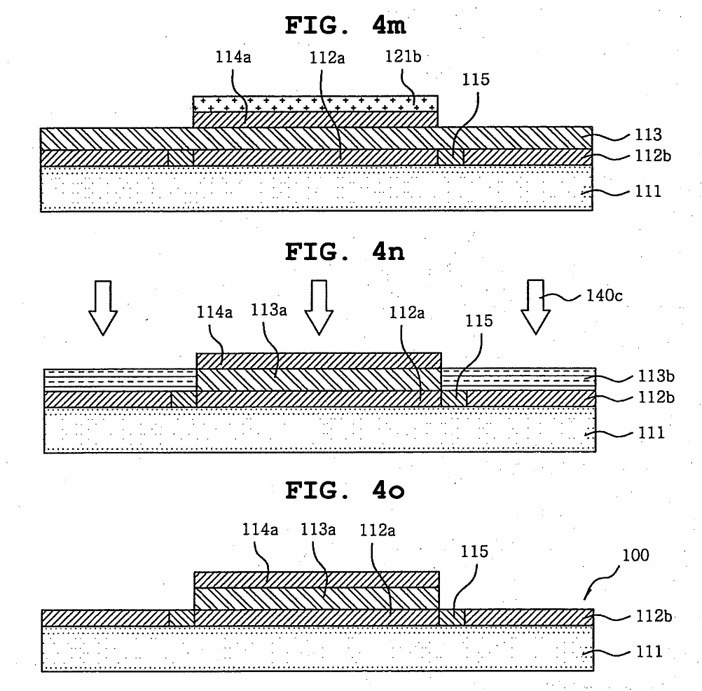

FIGS. 4a to 4o are sectional views illustrating a procedure of fabricating the PCB including the embedded capacitor, according to the present embodiment of the invention, in which a subtractive process is adopted to form the circuit pattern. Additionally, FIG. 5 is a plane view of the lower electrode layer of the PCB including the embedded capacitor which is fabricated through the procedure of FIGS. 4a to 4o.

As shown in FIG. 4a, a substrate, in which a first copper foil layer 112 is formed on the insulating layer 111, is prepared. In this figure, a structure in which the copper foil layer is formed on one side of the substrate is illustrated, but a multilayered substrate, in which predetermined circuit patterns and via holes are formed on internal layers, may be used according to the purpose or application.

As shown in FIG. 4b, a photosensitive film 120a (for example, dry film) is layered on the first copper foil layer 112.

As shown in FIG. 4c, a photomask 130a, on which a predetermined circuit pattern is formed, is closely adhered to the photosensitive film 120a and subsequently irradiated with ultraviolet rays 140a. At this stage, ultraviolet rays 140a penetrate an unprinted portion 131a of the photomask 130a to form a hardened portion 121a of the photosensitive film 120a under the photomask 130a. Ultraviolet rays 140a do not penetrate a black printed portion 132a of the photomask 130a, thus an unhardened portion 122a of the photosensitive film 120a remains under the photomask 130a.

As shown in FIG. 4d, after the photomask 130a is removed, a development process is conducted to remove the unhardened portion 122a of the photosensitive film 120a while only the hardened portion 121a of the photosensitive film 120a remains.

As shown in FIG. 4e, the first copper foil layer 112 is etched using the hardened portion 121a of the photosensitive film 120a as an etching resist, thereby forming the lower electrode layer 112a of the embedded capacitor and the circuit pattern 112b thereon.

As shown in FIG. 4f, the hardened portion 121a of the photosensitive film 120a is removed.

As shown in FIG. 4g, an insulating resin 115 is packed between the lower electrode layer 112a and the circuit pattern 112b, thus flattening a surface of the resulting layer. If a portion of the insulating resin 115 protrudes higher than the lower electrode layer 112a or the circuit pattern 112b, the protrusion of the insulating resin 115 is removed using a buff, thereby flattening the surface of the resulting layer, containing the lower electrode layer 112a and the circuit pattern 112b.

As shown in FIG. 4h, a photosensitive dielectric material 113 is applied on the lower electrode layer 112a, the circuit pattern 112b, and the insulating resin 115.

In another embodiment, if the photosensitive dielectric material 113 has good fluidity, since the photosensitive dielectric material 113 may be packed between the lower electrode layer 112a and the circuit pattern 112b in FIG. 4h, the packing of the insulating resin 115 as shown in FIG. 4g may be omitted.

As shown in FIG. 4i, a second copper foil layer 114 is laminated on the photosensitive dielectric material 113.

As shown in FIG. 4j, a photosensitive film 120b is layered on the second copper foil layer 114.

As shown in FIG. 4k, a photomask 130b, on which a predetermined circuit pattern is formed, is closely adhered to the photosensitive film 120b and subsequently irradiated with ultraviolet rays 140b. At this stage, ultraviolet rays 140b penetrate an unprinted portion 131b of the photomask 130b to form a hardened portion 121b of the photosensitive film 120b under the photomask 130b. Ultraviolet rays 140b do not penetrate a black printed portion 132b of the photomask 130b, thus an unhardened portion 122b of the photosensitive film 120b remains under the photomask 130b.

As shown in FIG. 41, after the photomask 130b is removed, a development process is conducted to remove the unhardened portion 122b of the photosensitive film 120b while only the hardened portion 121b of the photosensitive film 120b remains.

As shown in FIG. 4m, the second copper foil layer 114 is etched using the hardened portion 121b of the photosensitive film 120b as an etching resist, thereby forming an upper electrode layer 114a of the embedded capacitor thereon.

As shown in FIG. 4n, after the hardened portion 121b of the photosensitive film 120b is removed, ultraviolet rays 140c are radiated onto the photosensitive dielectric material 113 using the upper electrode layer 114a as a mask. At this stage, the portion of the photosensitive dielectric material 113 on which the upper electrode layer 114a is not formed absorbs ultraviolet rays 140c to form a reacted portion 113b, which is capable of being decomposed during a development process using a special solvent (for example, GBL (gamma-butyrolactone)). The other portion of the photosensitive dielectric material 113, on which the upper electrode layer 114a is formed, does not absorb ultraviolet rays 140c, resulting in the formation of an unreacted portion 113a.

As shown in FIG. 4o, the development process is conducted to remove the portion 113b of the photosensitive dielectric material 113, which reacted due to the ultraviolet rays, thereby forming a dielectric layer 113a of the embedded capacitor on the photosensitive dielectric material 113.

Subsequently, insulating layer lamination, circuit pattern formation, solder resist formation, nickel/gold plating, and external structure formation processes are implemented, thereby creating the PCB 100 including the embedded capacitor.

As described above, in the PCB 100 including the embedded capacitor according to the present embodiment of the invention, since the dielectric layer 113a and the upper electrode layer 114a are formed after the lower electrode layer 112a is formed, the embedded capacitor, which consists of the lower electrode layer 112a, the dielectric layer 113a, and the upper electrode layer 114a, has a flat wall as shown in FIG. 4o. In other words, the lower electrode layer 112a does not protrude from the dielectric layer 113a and the upper electrode layer 114a.

Furthermore, in the PCB 100 including the embedded capacitor according to the present embodiment of the invention, since the dielectric layer 113a and the upper electrode layer 114a are formed after the lower electrode layer 112a and the circuit pattern 112b are formed on the first copper foil layer 112, diffraction of ultraviolet rays 140a is insignificant at step of FIG. 4c.

Accordingly, as shown in FIG. 5, the PCB 100 including the embedded capacitor according to the present embodiment of the invention has an L/S (line/space) value of 20 ml/20 μm which denotes a width of the circuit pattern 112b, formed in conjunction with the lower electrode layer 112a, and a space between the circuit patterns 112b. The above value is a limit value in a process of forming a circuit pattern of a typical PCB.

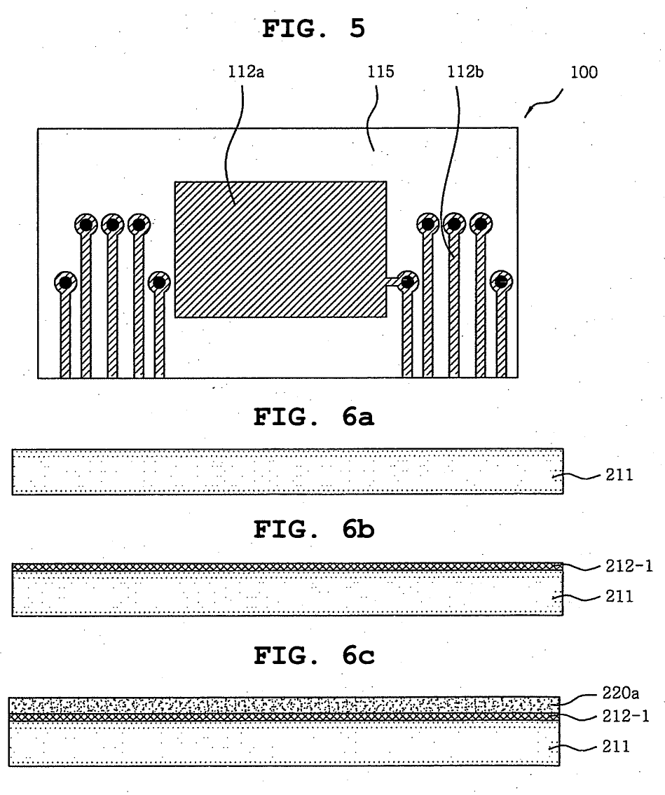

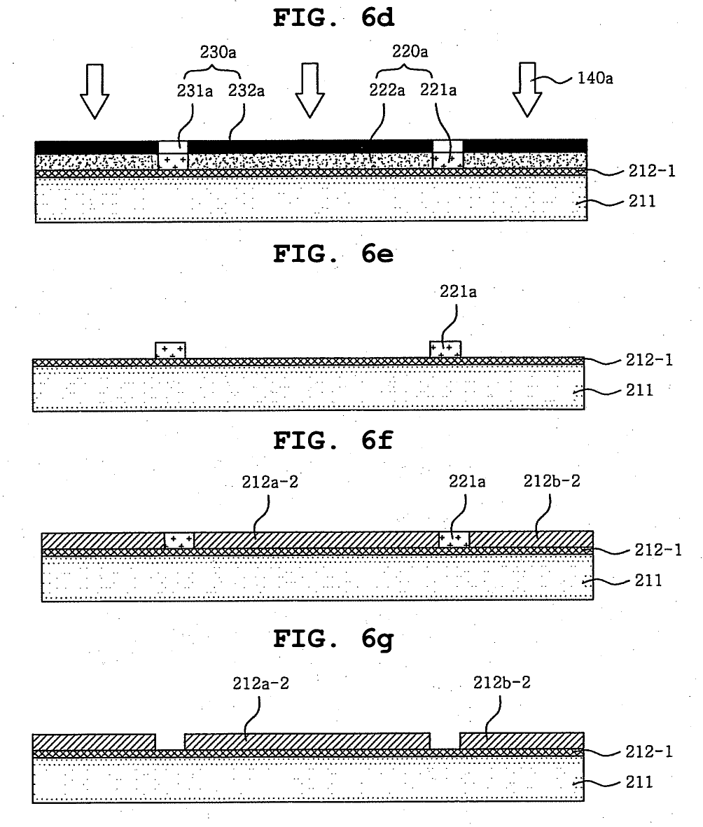

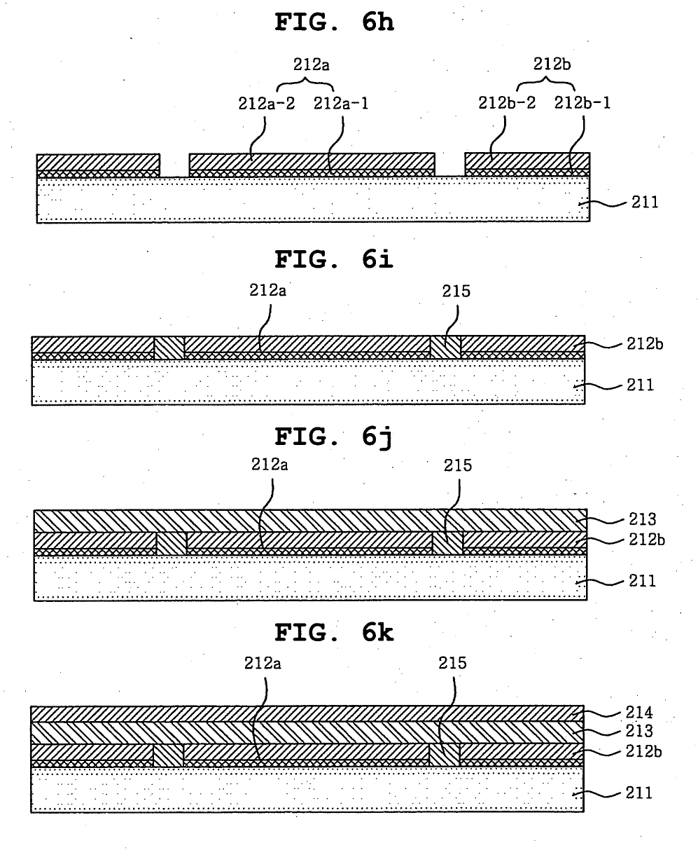

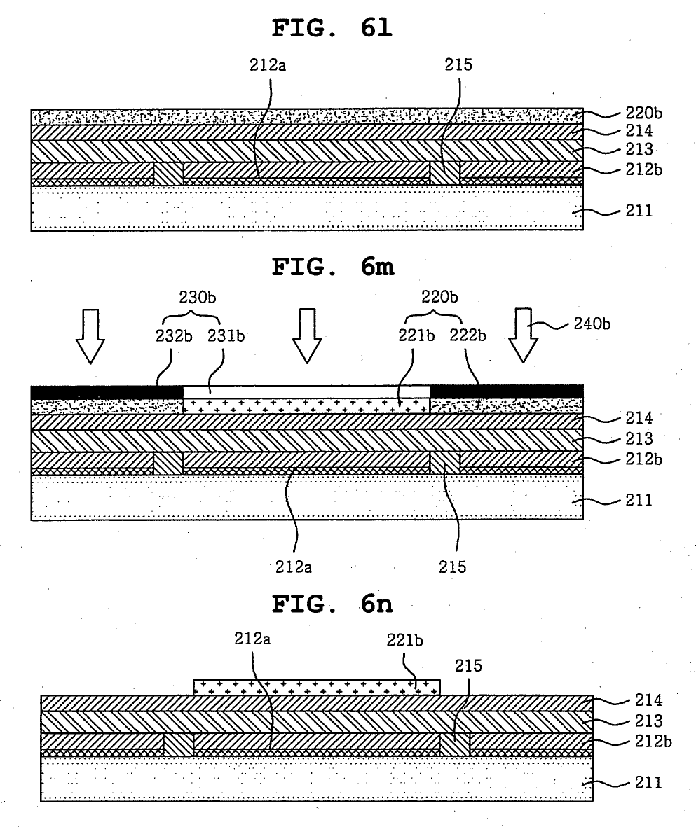

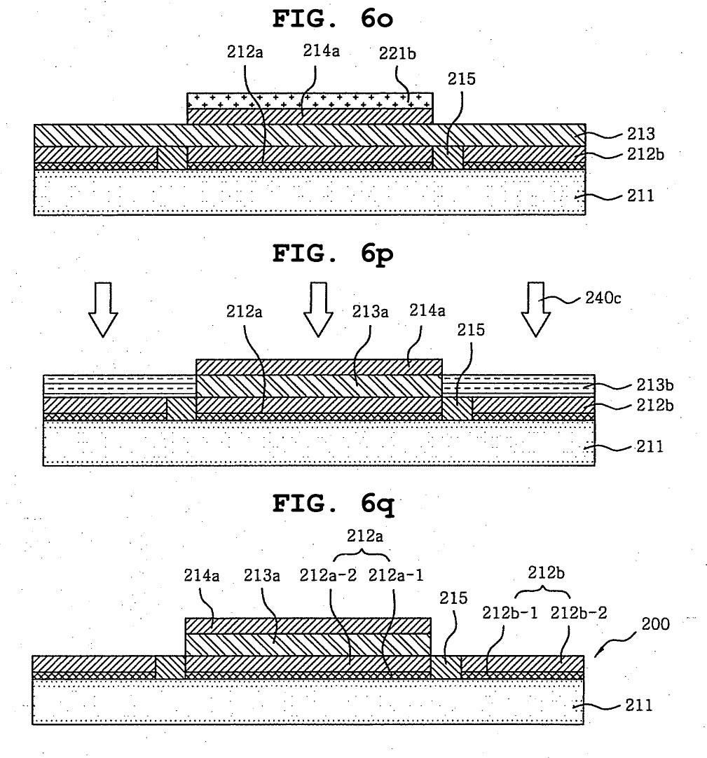

FIGS. 6a to 6q are sectional views illustrating a procedure of fabricating a PCB including an embedded capacitor, according to another embodiment of the present invention, in which a semi-additive process is adopted to form the circuit pattern.

As shown in FIG. 6a, an insulating layer 211, which consists of a reinforcing material and a thermosetting resin, is prepared as a substrate. In this figure, the insulating layer 211 acting as the substrate is illustrated, but a multilayered substrate, in which predetermined circuit patterns 212b and via holes are formed on internal layers and insulating layers are then laminated thereon, may be used according to the purpose or application.

As shown in FIG. 6b, an electroless copper plating layer 212-1 is formed on the insulating layer 211.

For example, the electroless copper plating layer 212-1 may be formed through a catalyst deposition process which includes degreasing, soft etching, pre-catalyst treatment, catalyst treatment, acceleration, electroless copper plating, and anti-oxidation steps.

Alternatively, the electroless copper plating layer 212-1 may be formed through a sputtering process in which gas ion particles (for example, Ar⁺), generated by a plasma or the like, collide with a copper target to form the electroless copper plating layer 212-1 on the insulating layer 211.

As shown in FIG. 6c, a photosensitive film 220a is applied on the electroless copper plating layer 212-1.

As shown in FIG. 6d, a photomask 230a, on which a predetermined circuit pattern is formed, is closely adhered to the photosensitive film 220a and subsequently irradiated with ultraviolet rays 240a. At this stage, ultraviolet rays 240a penetrate an unprinted portion 231a of the photomask 230a to form a hardened portion 221a of the photosensitive film 220a under the photomask 230a. Ultraviolet rays 240a do not penetrate a black printed portion 232a of the photomask 230a, thus an unhardened portion 222a of the photosensitive film 220a remains under the photomask 230a.

As shown in FIG. 6e, after the photomask 230a is removed, a development process is conducted to remove the unhardened portion 222a of the photosensitive film 220a while only the hardened portion 221a of the photosensitive film 220a remains.

As shown in FIG. 6f, an electrolytic copper plating process is conducted using the hardened portion 221a of the photosensitive film 220a as a plating resist, thereby forming electrolytic copper plating layers 212a-2, 212b-2 on the electroless copper plating layer 212-1.

At this stage, the substrate is immersed in a copper plating tub and the electrolytic copper plating process is then conducted using a DC rectifier (direct current rectifier) so as to form the electrolytic copper plating layers 212a-2, 212b-2. It is preferable to conduct the electrolytic copper plating process through a method in which a proper amount of electricity is applied by the DC rectifier to the substrate based on the calculated area of substrate to be plated with copper, thereby depositing copper on the substrate.

The electrolytic copper plating process is advantageous in that the electrolytic copper plating layer has physical properties superior to the electroless copper plating layer, and that it is easy to form a thick copper plating layer.

Separate incoming lines for copper-plating may be used to form the electrolytic copper plating layers 212a-2, 212b-2. However, in the present invention, it is preferable to use the electroless copper plating layer 212-1 as the incoming line for forming the electrolytic copper plating layers 212a-2, 212b-2.

As shown in FIG. 6g, the hardened portion 221a of the photosensitive film 220a is removed.

As shown in FIG. 6h, a flash etching process is implemented so as to remove the portion of the electroless copper plating layer 212-1 on which the electrolytic copper plating layers 212a-2, 212b-2 are not formed. Thereby, a lower electrode layer 212a and a circuit pattern 212b of the embedded capacitor are formed on the electroless copper plating layers 212a-1, 212b-1 and the electrolytic copper plating layers 212a-2, 212b-2.

As shown in FIG. 6i, an insulating resin 215 is packed between the lower electrode layer 212a and the circuit pattern 212b, thereby flattening the surface of the resulting layer. If a portion of the insulating resin 215 protrudes higher than the lower electrode layer 212a or the circuit pattern 212b, the protrusion of the insulating resin 215 is removed using a buff, thereby flattening the surface of the resulting layer containing the lower electrode layer 212a and the circuit pattern 212b.

As shown in FIG. 6j, a photosensitive dielectric material 213 is applied on the lower electrode layer 212a, the circuit pattern 212b, and the insulating resin 215.

As in the previous embodiment, if the photosensitive dielectric material 213 has good fluidity, since the photosensitive dielectric material 213 may be packed between the lower electrode layer 212a and the circuit pattern 212b in FIG. 6j, the packing of the insulating resin 215 as shown in FIG. 6i may be omitted.

As shown in FIG. 6k, a copper foil layer 214 is laminated on the photosensitive dielectric material 213.

As shown in FIG. 61, a photosensitive film 220b is applied on the copper foil layer 214.

As shown in FIG. 6m, a photomask 230b, on which a predetermined capacitor pattern is formed, is closely adhered to the photosensitive film 220b and subsequently irradiated with ultraviolet rays 240b. At this stage, ultraviolet rays 240b penetrate an unprinted portion 231b of the photomask 230b to form a hardened portion 221b of the photosensitive film 220b under the photomask 230b. Ultraviolet rays 240b do not penetrate a black printed portion 232b of the photomask 230b, thus an unhardened portion 222b of the photosensitive film 220b remains under the photomask 230b.

As shown in FIG. 6n, after the photomask 230b is removed, a development process is conducted to remove the unhardened portion 222b of the photosensitive film 220b while only the hardened portion 221b of the photosensitive film 220b remains.

As shown in FIG. 6o, the copper foil layer 214 is etched using the hardened portion 221b of the photosensitive film 220b as an etching resist, thereby forming an upper electrode layer 214a of the embedded capacitor thereon.

As shown in FIG. 6p, after the hardened portion 221b of the photosensitive film 220b is removed, ultraviolet rays 240c are radiated onto the photosensitive dielectric material 213 using the upper electrode layer 214a as a mask. At this stage, the portion of the photosensitive dielectric material 213 on which the upper electrode layer 214a is not formed absorbs ultraviolet rays 240c to form a reacted portion 213b, which is capable of being decomposed during a development process using a special solvent. The other portion of the photosensitive dielectric material 213, on which the upper electrode layer 214a is formed, does not absorb ultraviolet rays 240c, resulting in the formation of an unreacted portion 213a.

As shown in FIG. 6q, the development process is conducted to remove the portion 213b of the photosensitive dielectric material 213 which was hardened by the ultraviolet rays, thereby forming a dielectric layer 213a of the embedded capacitor on the photosensitive dielectric material 213.

Subsequently, insulating layer lamination, circuit pattern formation, solder resist formation, nickel/gold plating, and external structure formation processes are implemented, thereby creating the PCB 200 including the embedded capacitor.

As in the previous embodiment, in the PCB 200 including the embedded capacitor according to the present embodiment of the invention, since the dielectric layer 213a and the upper electrode layer 214a are formed after the lower electrode layer 212a is formed, it is possible to form the microcircuit pattern 212b on the electroless copper plating layer 212b-1 and the electrolytic copper plating layer 212b-2 while the lower electrode layer 212a does not protrude from the dielectric layer 213a and the upper electrode layer 214a.

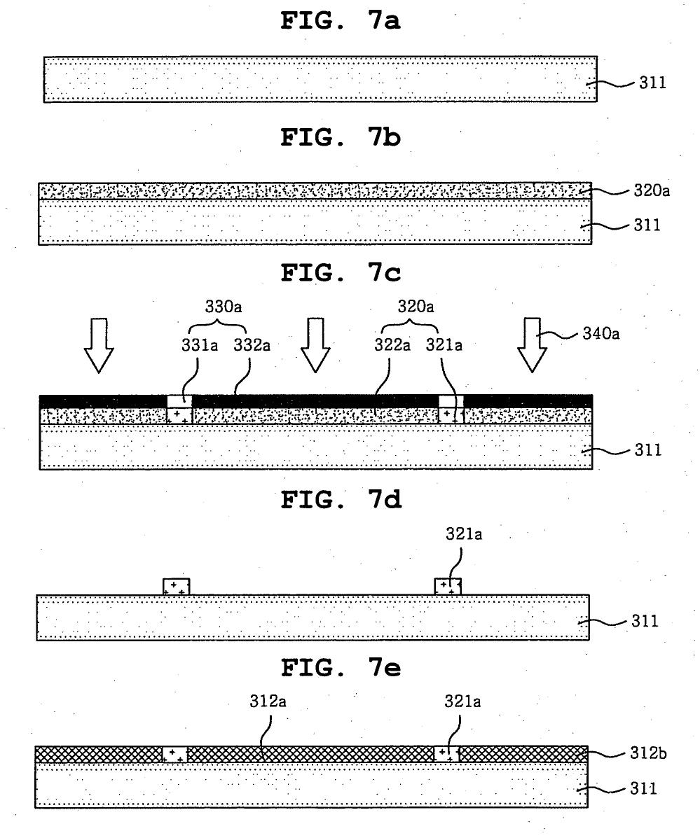

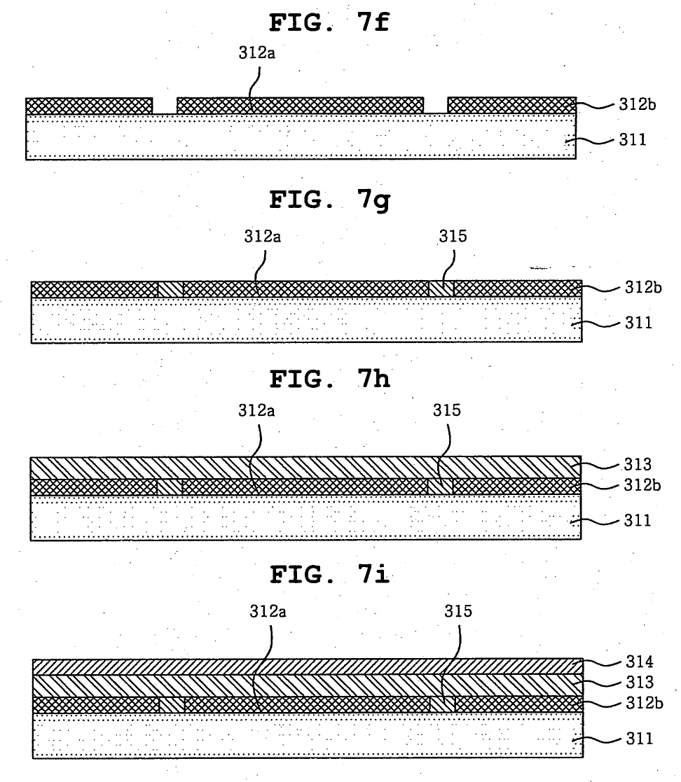

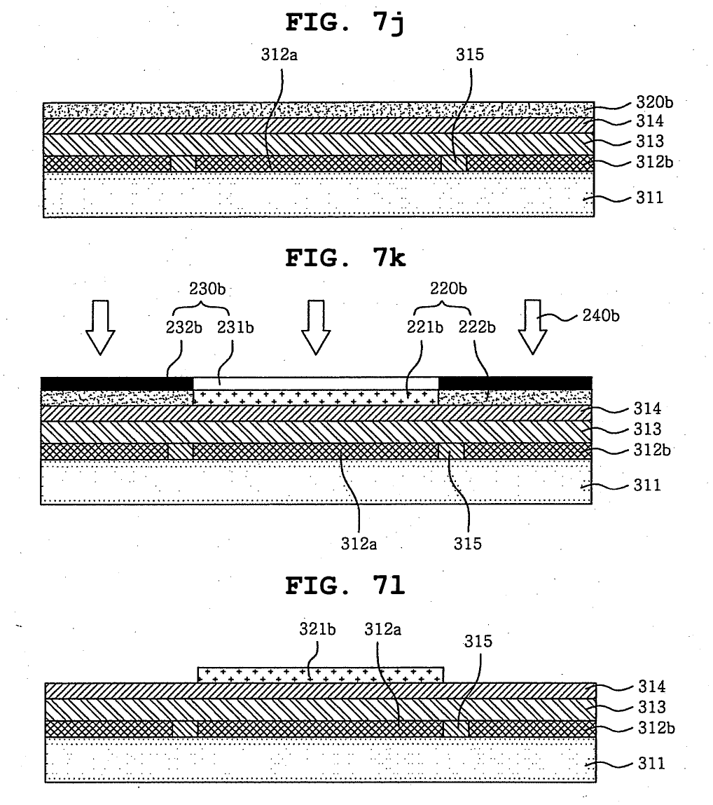

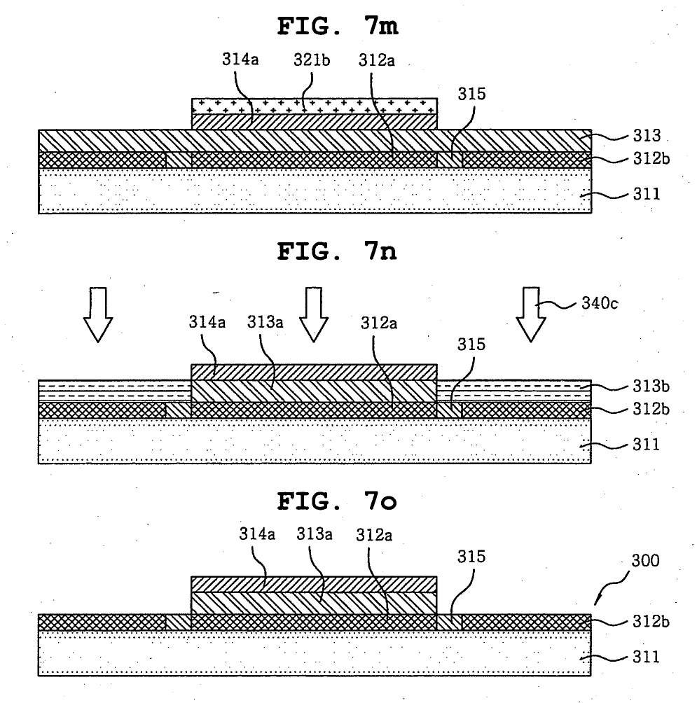

FIGS. 7a to 7o are sectional views illustrating a procedure of fabricating a PCB including an embedded capacitor, according to yet another embodiment of the present invention, in which a full additive process is adopted to form a circuit pattern.

As shown in FIG. 7a, an insulating layer 311, which consists of a reinforcing material and a thermosetting resin, is prepared as a substrate. In this figure, the insulating layer 311 acting as the substrate is illustrated, but a multilayered substrate, in which predetermined circuit patterns and via holes are formed on internal layers and insulating layers are then laminated thereon, may be used according to the purpose or application.

As shown in FIG. 7b, a photosensitive film 320a is applied on the insulating layer 311.

As shown in FIG. 7c, a photomask 330a, on which a predetermined circuit pattern is formed, is closely adhered to the photosensitive film 320a and subsequently irradiated with ultraviolet rays 340a. At this stage, ultraviolet rays 340a penetrate an unprinted portion 331a of the photomask 330a to form a hardened portion 321a of the photosensitive film 320a under the photomask 330a. Ultraviolet rays 340a do not penetrate a black printed portion 332a of the photomask 330a, thus an unhardened portion 322a of the photosensitive film 320a remains under the photomask 330a.

As shown in FIG. 7d, after the photomask 330a is removed, a development process is conducted to remove the unhardened portion 322a of the photosensitive film 320a while only the hardened portion 321a of the photosensitive film 320a remains.

As shown in FIG. 7e, an electroless copper plating process is conducted using the hardened portion 321a of the photosensitive film 320a as a plating resist, thereby forming a lower electrode layer 312a of the embedded capacitor and a circuit pattern 312b on the insulating layer 311.

In this respect, formation of an electroless copper plating layer may be achieved through catalyst deposition and sputtering processes.

As shown in FIG. 7f, the hardened portion 321a of the photosensitive film 320a is removed.

As shown in FIG. 7g, an insulating resin 315 is packed between the lower electrode layer 312a and the circuit pattern 312b, thus flattening the surface of the resulting layer. If a portion of the insulating resin 315 protrudes higher than the lower electrode layer 312a or the circuit pattern 312b, the protrusion of the insulating resin 315 is removed using a buff, thereby flattening the surface of the resulting layer, containing the lower electrode layer 312a and the circuit pattern 312b.

As shown in FIG. 7h, a photosensitive dielectric material 313 is applied on the lower electrode layer 312a, the circuit pattern 312b, and the insulating resin 315.

As in the above embodiments, if the photosensitive dielectric material 313 has good fluidity, since the photosensitive dielectric material 313 may be packed between the lower electrode layer 312a and the circuit pattern 312b in FIG. 7h, the packing of the insulating resin 315 as shown in FIG. 7g may be omitted.

As shown in FIG. 7i, a copper foil layer 314 is laminated on the photosensitive dielectric material 313.

As shown in FIG. 7j, a photosensitive film 320b is applied on the copper foil layer 314.

As shown in FIG. 7k, a photomask 330b, on which a predetermined capacitor pattern is formed, is closely adhered to the photosensitive film 320b and subsequently irradiated with ultraviolet rays 340b. At this stage, ultraviolet rays 340b penetrate an unprinted portion 331b of the photomask 330b to form a hardened portion 321b of the photosensitive film 320b under the photomask 330b. Ultraviolet rays 340b do not penetrate a black printed portion 332b of the photomask 330b, thus an unhardened portion 322b of the photosensitive film 320b remains under the photomask 330b.

As shown in FIG. 71, after the photomask 330b is removed, a development process is conducted to remove the unhardened portion 322b of the photosensitive film 320b while only the hardened portion 321b of the photosensitive film 320b remains.

As shown in FIG. 7m, the copper foil layer 314 is etched using the hardened portion 321b of the photosensitive film 320b as an etching resist, thereby forming an upper electrode layer 314a of the embedded capacitor thereon.

As shown in FIG. 7n, after the hardened portion 321b of the photosensitive film 320b is removed, ultraviolet rays 340c are radiated onto the photosensitive dielectric material 313 using the upper electrode layer 314a as a mask. At this stage, a portion of the photosensitive dielectric material 313, on which the upper electrode layer 314a is not formed, absorbs ultraviolet rays 340c to form a reacted portion 313b, which is capable of being decomposed during a development process using a special solvent. The other portion of the photosensitive dielectric material 313, on which the upper electrode layer 314a is formed, does not absorb ultraviolet rays 340c, resulting in the formation of an unreacted portion 313a.

As shown in FIG. 7o, the development process is conducted to remove the portion 313b of the photosensitive dielectric material 313 which reacted due to the ultraviolet rays, thereby forming a dielectric layer 313a of the embedded capacitor on the photosensitive dielectric material 313.

Subsequently, insulating layer lamination, circuit pattern formation, solder resist formation, nickel/gold plating, and external structure formation processes are implemented, thereby creating the PCB 300 including the embedded capacitor.

As in the above embodiments, in the PCB 300 including the embedded capacitor according to the present embodiment of the invention, since the dielectric layer 313a and the upper electrode layer 314a are formed after the lower electrode layer 312a is formed, it is possible to form the microcircuit pattern 312b on the electroless copper plating layer while the lower electrode layer 312a does not protrude from the dielectric layer 313a and the upper electrode layer 314a.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

As described above, a PCB including an embedded capacitor and a method of fabricating the same according to the present invention are advantageous in that since a dielectric layer and an upper electrode layer are formed after a lower electrode layer and a circuit pattern are formed, the circuit pattern, which is formed in conjunction with the lower electrode layer, is made fine.

Another advantage is that since the dielectric layer and the upper electrode layer are formed after the lower electrode layer and the circuit pattern are formed, a portion of the lower electrode layer does not protrude from the dielectric layer and the upper electrode layer, thereby preventing the occurrence of parasitic inductance.

Still another advantage is that since an unnecessary portion of the lower electrode layer is not formed, it is possible to reduce the size of the lower electrode layer and the size of the whole embedded capacitor.

Yet another advantage is that since the microcircuit pattern and the smaller embedded capacitor are provided, the PCB including the embedded capacitor and the method of fabricating the same according to the present invention can be applied to highly integrated and miniaturized electronic goods.

What is claimed is:

1. A printed circuit board including an embedded capacitor, comprising:
an insulating layer;
a lower electrode layer formed on the insulating layer;
a circuit pattern formed around the lower electrode layer of the insulating layer;
an insulating resin which is packed between the lower electrode layer and the circuit pattern to provide insulation between the lower electrode layer and the circuit pattern;
a dielectric layer formed on the lower electrode layer; and
an upper electrode layer formed on the dielectric layer.

2. The printed circuit board as set forth in claim 1, wherein the embedded capacitor has a flat wall.

3. The printed circuit board as set forth in claim 1, wherein the dielectric layer is made of a photosensitive dielectric material.

4. A method of fabricating a printed circuit board including an embedded capacitor, comprising the steps of:
(A) forming a lower electrode layer on an insulating layer and a circuit pattern around the lower electrode layer;
(B) layering a photosensitive dielectric material on the lower electrode layer and the circuit pattern, and laminating a copper foil layer on the photosensitive dielectric material;
(C) etching the copper foil layer through a photolithography process so as to form an upper electrode layer on a portion of the copper foil layer, which corresponds in position to the lower electrode layer; and
(D) exposing and developing the photosensitive dielectric material using the upper electrode layer as a mask so as to form a dielectric layer on the photosensitive dielectric material.

5. The method as set forth in claim 4, further comprising the steps of:
(E) packing an insulating resin between the lower electrode layer and the circuit pattern to flatten a surface of a layer, containing the lower electrode layer and the circuit pattern, after the step (A).

6. The method as set forth in claim 4, wherein the lower electrode layer and the circuit pattern of step (A) are formed by at least one subtractive, semi-additive, or full additive processes.
